(19) United States
(12) Patent Application Publication
(10) Pub. No.: US 2014/0149480 A1
(43) Pub. Date: May 29, 2014

(54) SYSTEM, METHOD, AND COMPUTER PROGRAM PRODUCT FOR TRANSPOSING A MATRIX

(71) Applicant: NVIDIA Corporation, Santa Clara, CA (US)

(72) Inventors: Bryan Christopher Catanzaro, Cupertino, CA (US); Manjunath Kudlur, San Jose, CA (US)

(73) Assignee: NVIDIA Corporation, Santa Clara, CA (US)

(21) Appl. No.: 14/062,820

(22) Filed: Oct. 24, 2013

Related U.S. Application Data
(60) Provisional application No. 61/730,909, filed on Nov. 28, 2012.

(51) Int. Cl. G06F 17/16

(52) U.S. Cl. CPC G06F 17/16
USPC 708/520

(57) ABSTRACT

A system, method, and computer program product are provided for transposing a matrix. In use, a matrix is identified. Additionally, the matrix is transposed utilizing row-wise operations and column-wise operations, where the row-wise operations and the column-wise operations are performed independently.

### CLAIM OF PRIORITY

This application claims the benefit of U.S. Provisional Application No. 61/730,909, filed Nov. 28, 2012, which is incorporated herein by reference.

### FIELD OF THE INVENTION

The present invention relates to matrix transposition, and more particularly to decomposing in-place matrix transposition.

### BACKGROUND

Traditionally, in-place matrix transposition has been practiced in the context of computer memory utilization. For example, transposing matrices may be desirable in a number of computer-implemented situations. However, current techniques for implementing in-place matrix transposition have been associated with various limitations.

For example, current methodologies for performing in-place matrix transposition are inefficient and exhibit poorly distributed load balancing when implemented in parallel hardware. There is thus a need for addressing these and/or other issues associated with the prior art.

### SUMMARY

A system, method, and computer program product are provided for transposing a matrix. In use, a matrix is identified. Additionally, the matrix is transposed utilizing row-wise operations and column-wise operations, where the row-wise operations and the column-wise operations are performed independently.

### BRIEF DESCRIPTION OF THE DRAWINGS

FIG. 1 shows a method for transposing a matrix, in accordance with one embodiment.

FIG. 2 shows a method for performing a decomposed in-place matrix transposition, in accordance with another embodiment.

FIG. 3 illustrates examples of two transposition permutations, in accordance with another embodiment.

FIG. 4 shows a transposition of a 2×3 dimensional matrix, laid out in row-major order, using a C2R transposition permutation, in accordance with another embodiment.

FIG. 5 illustrates an exemplary system in which the various architecture and/or functionality of the various previous embodiments may be implemented.

### DETAILED DESCRIPTION

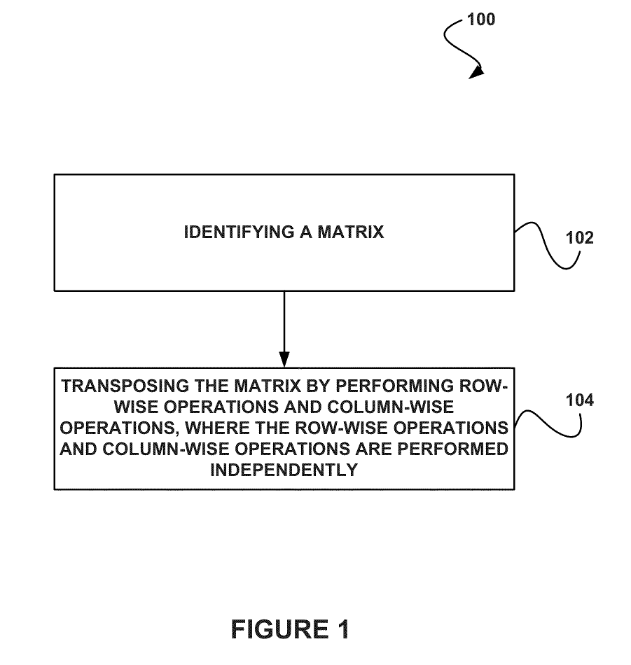

FIG. 1 shows a method 100 for transposing a matrix, in accordance with one embodiment. As shown in operation 102, a matrix is identified. In one embodiment, the matrix may include an array of entries. For example, the matrix may include a rectangular array of entries (e.g., data such as numbers, symbols, expressions, etc.). In another embodiment, the array of entries may include a plurality of rows and a plurality of columns. For example, the array of entries may include an array of entries arranged in rows and columns. In yet another embodiment, the matrix may represent data to be processed, data to be stored, etc.

Additionally, as shown in operation 104, the matrix is transposed by performing row-wise operations and column-wise operations, where the row-wise operations and the column-wise operations are performed independently. In one embodiment, the matrix may be transposed utilizing a transposition. For example, the matrix may be transposed utilizing a row-to-column (R2C) transposition. In another example, the matrix may be transposed utilizing a column-to-row (C2R) transposition.

Further, in one embodiment, the row-wise operations may include operations that are performed on a row of the identified matrix. For example, the row-wise operations may include a row shuffle operation that selects a row of the matrix and rearranges the elements within the row of the matrix. For instance, the row shuffle operation may create a reordered row containing a rearrangement of the elements within a row of the matrix, where the rearrangement is made according to an order identified by an input vector. In another example, the row of the matrix may be overwritten with the reordered row.

Further still, in one embodiment, the column-wise operations may include operations that are performed on a column of the identified matrix. For example, the column-wise operations may include a column shuffle operation. In another embodiment, the column-wise operations may include a column rotation operation that rotates a column of the matrix by a predetermined distance, such that elements are consecutively removed from the top of the column and added to the bottom of the column. In yet another embodiment, the column-wise operations may include a row permutation operation that interchanges an entire row of the matrix with another entire row of the matrix. In yet another embodiment, the column-wise operations may include a column shuffle operation that may include the column rotation operation and the row permutation operation.

Also, in one embodiment, the row-wise operations and the column-wise operations may be performed independently such that each operation may be performed independently of the other operations. For example, all row-wise operations may be performed independently from all column-wise operations. In another embodiment, conflicts may be avoided when the row-wise operations and the column-wise operations are performed. For example, all row-wise operations and column-wise operations may be performed without needing to send one or more elements in the matrix to more than one location within the matrix at the same time. In this way, hardware that performs the transposing may be simplified, since no replay machinery may be needed to handle conflicts in the hardware.

In addition, in one embodiment, transposing the matrix may include preparing the matrix to eliminate conflicts. For example, the matrix may be prepared by performing one or more column shuffle operations on the matrix. In one embodiment, the matrix may be prepared by rotation operations and row permutation operations on the matrix. In another embodiment, transposing the matrix may include performing one or more row shuffle operations on the matrix once the matrix has been prepared to eliminate conflicts. In yet another embodiment, transposing the matrix may include performing one or more column rotation operations and one or more row permutation operations to ensure the entries in the matrix are in the proper order after the one or more row shuffle operations have been performed.

Furthermore, in one embodiment, auxiliary storage may be used when transposing the matrix. For example, when transposing the matrix, auxiliary storage may be used to store a row or column of the matrix. In another embodiment, identifying and transposing the matrix may be performed as part of one or more single instruction, multiple data (SIMD) vector memory accesses. In yet another embodiment, identifying and transposing the matrix may be performed as part of one or more database format conversions (e.g., format conversions between a row-oriented database format to a column-oriented database format, etc.). In still another embodiment, identifying and transposing the matrix may be performed as part of a memory controller implementation.

In this way, the procedure for transposing the matrix may be decomposed into row-wise and column-wise operations that are performed on the matrix, where the operations may not have interdependencies and may be executed in parallel, which may enable improved load balancing. Additionally, the scope of each operation may be reduced to a single row or column of the matrix, which may reduce the time complexity of the matrix transposition when auxiliary storage space is limited.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

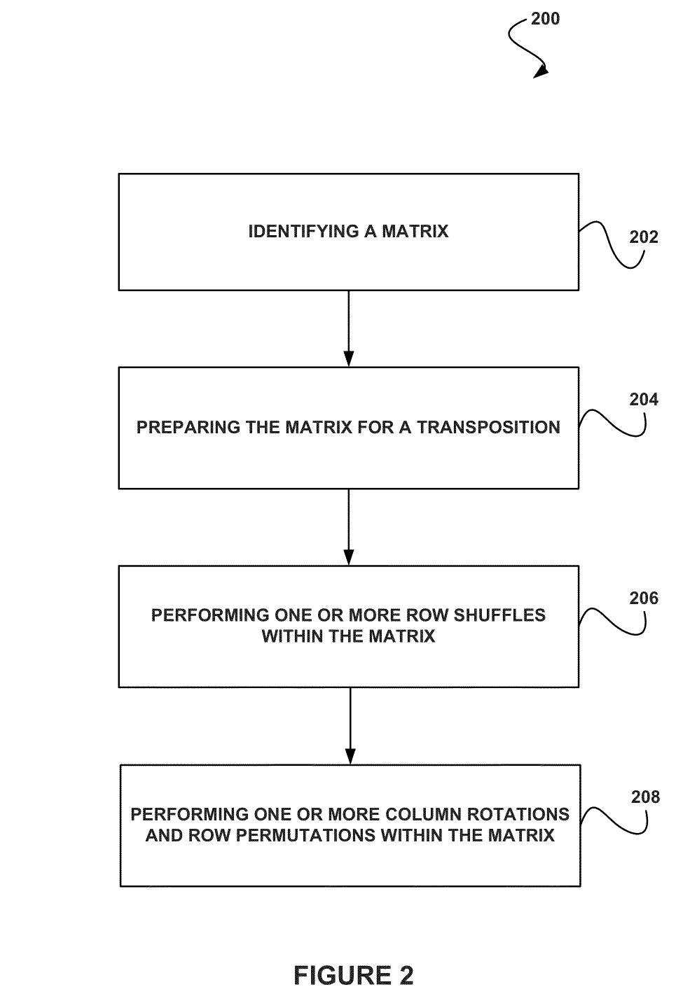

FIG. 2 shows a method 200 for performing a decomposed in-place matrix transposition, in accordance with another embodiment. As an option, the method 200 may be carried out in the context of the functionality of FIG. 1. Of course, however, the method 200 may be implemented in any desired environment. It should also be noted that the aforementioned definitions may apply during the present description.

As shown in operation 202, a matrix is identified. In one embodiment, the matrix may include an input matrix (e.g., a matrix input for processing, etc.). Additionally, as shown in operation 204, the matrix is prepared for the transposition. In one embodiment, preparing the matrix for the transposition my include preparing the matrix to eliminate any conflicts that may otherwise arise during the transposition. In another embodiment, preparing the matrix for the transposition may include performing one or more column rotations.

For example, performing a column rotation may include rotating a column by a predetermined distance. Table 1 illustrates an exemplary rotation of a column vector d of m data items, given a rotation amount k, in accordance with one embodiment. Of course, it should be noted that the exemplary rotation shown in Table 1 is set forth for illustrative purposes only, and thus should not be construed as limiting in any manner,

TABLE 1

dᵢ′ = d₍ᵢ₊ₖ₎ mod m

As shown in Table 1, the result of rotating the vector d is another vector d′. In one embodiment, the column rotation may include a dynamic column rotate operation. Table 2 illustrates a column rotation that is performed on an entire matrix, in accordance with one embodiment. Of course, it should be noted that the exemplary rotation shown in Table 2 is set forth for illustrative purposes only, and thus should not be construed as limiting in any manner.

TABLE 2
Consider a row vector of rotations r with n elements, where each element
is bounded: 0 ≦ rⱼ < m ∀j. After rotation:

aᵢⱼ′ = a₍₍ᵢ₊ᵣ_{ⱼ}_{) mod m i, j}

Further, in one embodiment, preparing the matrix for the transposition may include performing one or more row permutations. In one embodiment, a row permutation may include a static row permute operation. For example, performing a row permutation may include interchanging a row of a matrix with another row of the matrix. Table 3 illustrates an exemplary row permutation of a column vector d of m data items held by a processing element, in accordance with one embodiment. Of course, it should be noted that the exemplary row permutation shown in Table 3 is set forth for illustrative purposes only, and thus should not be construed as limiting in any manner.

TABLE 3
Given a column vector of permutations p, where each each element is
bounded 0 ≦ pᵢ < m ∀i, the result of permuting d is another vector d′:

dᵢ′ = dₚᵢ

Table 4 illustrates an exemplary aggregation of row permutations across all columns of a matrix, in accordance with one embodiment. Of course, it should be noted that the exemplary aggregation shown in Table 4 is set forth for illustrative purposes only, and thus should not be construed as limiting in any manner.

TABLE 4
Aggregating permutations across all columns, this forms a permutation of
the rows of A:

aᵢⱼ′ = a_{pi, j}

Further, as shown in operation 206, one or more row shuffles are performed within the matrix. In one embodiment, a row shuffle may include an arbitrary permutation across rows of the matrix. For example, the row shuffle may create a reordered row containing a rearrangement of the elements within a row of the matrix, where the rearrangement is made according to an order identified by an input vector, and where the row of the matrix may be overwritten with the reordered row.

Table 5 illustrates an exemplary single row shuffle, in accordance with one embodiment. Of course, it should be noted that the exemplary row shuffle shown in Table 5 is set forth for illustrative purposes only, and thus should not be construed as limiting in any manner.

TABLE 5
Consider a vector
d of n data items, and another vector x of n indices, where processing ele-
ment j produces dⱼ and xⱼ. The result of shuffle is another vector d′, of n
data items:

dⱼ′ = dₓ_{ᵢ}

Table 6 illustrates the performance of one or more row shuffles row-wise across a matrix of data items A, in accordance with one embodiment. Of course, it should be noted that the one or more shuffles shown in Table 6 are set forth for illustrative purposes only, and thus should not be construed as limiting in any manner.

TABLE 6
It is convenient to consider this operation as a shuffle operation which
takes the matrix of data items A, an m × n matrix of indices S, and
produces a shuffled matrix A′:

aᵢⱼ′ = aᵢ,ₛ_{ᵢⱼ}

Further still, as shown in operation 208, one or more column rotations and row permutations are performed within the matrix. In one embodiment, the one or more column rotations and row permutations may be performed within the matrix to ensure that data within the matrix is in the proper order according to the transposition. In another embodiment, the choice of column rotations and row permutations may encode the matrix. In yet another embodiment, the row shuffle operations, column rotation operations, and row permutations operations may be restricted to work across only one dimension of the matrix. In this way, the decomposition may reduce a time complexity of the transposition when auxiliary storage space is limited, by reducing the scope of each permutation to a single row or column. The permutations on rows and columns may also have particular properties that make them amenable for implementation on SIMD processors or in VLSI hardware.

Also, in one embodiment, the decomposed in-place matrix transposition may include a column to row (C2R) matrix transposition permutation. Table 7 illustrates an exemplary C2R transposition, in accordance with one embodiment. Of course, it should be noted that the C2R transposition shown in Table 7 is set forth for illustrative purposes only, and thus should not be construed as limiting in any manner.

TABLE 7

```
For matrix dimensions m, n ∈ [symbol]   ⁺, define
$c = gcd ( m , n ) a = \frac{m}{c} b = \frac{n}{c}$
Also, we use the modular multiplicative inverse function mmi
(x,y), which is defined for coprime integers x and y:
(x · mmi(x, y)) mod y = 1
Then, the transposition is as follows:
  A ← rotate(A, p)
  A ← shuffle(A, S)
  A ← rotate(A, r)
  A ← permute(A, q)
  Where:
k = mmi(a, b)
$f ( i , j ) = \{ \begin{matrix}j + i ( n - 1 ) & i - ( j mod c ) \leq m - c \\ j + i ( n - 1 ) + m & i - ( j mod c ) > m - c\end{matrix}$
And the indices for each of the steps are:
${p}_{j} = ⌊ \frac{j}{b} ⌋$
${s}_{ij} = ( k ⌊ \frac{f ( i , j )}{c} ⌋ mod b ) + ( f ( i , j ) mod c ) \cdot b$
rⱼ = j mod m
${q}_{i} = ( i \cdot n - ⌊ \frac{i}{a} ⌋ ) mod m$
```

Additionally, in one embodiment, the decomposed in-place matrix transposition may include a row to column (R2C) matrix transposition permutation. Table 8 illustrates an exemplary R2C transposition, in accordance with one embodiment. Of course, it should be noted that the R2C transposition shown in Table 8 is set forth for illustrative purposes only, and thus should not be construed as limiting in any manner.

TABLE 8

```
For matrix dimensions m, n ∈ [symbol]   ⁺, define
$c = gcd ( m , n ) a = \frac{m}{c} b = \frac{n}{c}$
Also, we use the modular multiplicative inverse function mmi (x,y),
which is defined for coprime integers x and y:
(x · mmi(x,y)) mod y = 1
The Rows to Columns transpose is simply the Columns to Rows
transpose in reverse, with all operations inverted
    The transposition is as follows:
  A ← permute(A, p)
  A ← rotate(A, d)
  A ← shuffle(A, S)
  A ← rotate(A, r)
    Where:
q = mmi(b,a)
    And the indices for each of the steps are:
${p}_{i} = ( ( ( c - 1 ) \cdot i ) mod c ) \cdot a + ( ( ⌊ \frac{c - 1 + i}{c} ⌋ \cdot q ) mod a )$
dⱼ = m − (j mod m)
${s}_{ij} = ( ( i + ⌊ \frac{j}{b} ⌋ ) mod m + j \cdot m ) mod n$
${r}_{j} = m - ⌊ \frac{j}{b} ⌋$
```

In one embodiment, the above operations may be implemented efficiently through strength reduction and static precomputation. Executing the transposition may then involve shuffle primitives, and m┌log₂(m)┐ SIMD select operations per dynamic column rotation, of which there may be one or two, depending on the algorithm specialization. In another embodiment, the transpose mechanism may enable higher throughput, both when performing unit strided vector memory accesses, as well as when performing randomized vector memory addresses. These vector memory accesses may be applied to improve the efficiency of many tasks, such as Array of Structures SIMD loads and stores, SIMD register blocked algorithms) where each SIMD lane consumes or produces a vector of data), interleaving multiple arrays into a single array, deinterleaving a single array into multiple arrays, etc.

In this embodiment, the transpose operates in-place on registers, obviating the need for on-chip memory to perform the transpose. This allows the creation of high-level software constructs that perform the transpose automatically whenever a memory reference to a large type is dereferenced.

Further, in one embodiment, the decomposed in-place matrix transposition may be used to perform a general matrix transpose. For example, the decomposition may break the transpose into row-wise and column-wise operations on the matrix. These operations may have no interdependences and can be executed in parallel, with perfect load balance. In another embodiment, the C2R transpose may be implemented to create an in-place matrix transpose for row-major and column-major matrices. This transpose may require auxiliary storage for a row or a column of the matrix, whichever is biggest.

Further still, in one embodiment, parallel implementations may require auxiliary storage with a row or a column for every parallel task transposing the matrix. For example, on a Tesla K20c, registers may be used for the auxiliary space if the size of the row or column is less than approximately 40000 elements (single precision) or 20000 elements (double precision). In another embodiment, space may be allocated for a few rows or columns to perform the transpose.

Also, in one embodiment, the decomposed in-place matrix transposition may be used to perform SIMD vector memory accesses. For example, algorithms mapped onto SIMD multiprocessors may require vector loads and stores. Programmers may strive to increase the amount of sequential work that can be mapped onto a SIMD lane, in order to reduce the algorithmic overhead of parallelization; this may require vector loads and stores because each SIMD lane is consuming or producing a vector of data. Similarly, directly operating on Arrays of Structures (AoS) may be convenient for programmers, but also may require arbitrary length vector loads and stores, as each SIMD lane loads or stores a structure.

Although most processors provide limited vector loads and stores for a few fixed datatypes, using them may be inconvenient and suboptimal, since the size of a desired vector load or store may not map cleanly to the vector loads and stores provided by the hardware. Using compiler generated loads and stores for arbitrarily sized vector accesses often interacts poorly with the memory subsystem, since the vector loads and stores are not exposed to the memory subsystem, but instead are presented as a sequential series of strided memory operations, leading to poor memory bandwidth utilization.

Decomposed in-place transpositions may enable maximally efficient, arbitrary length vector loads and stores. This technique may be instantiated in VLSI circuits or reprogrammable logic to create memory controllers that provide SIMD memory accesses with arbitrary length per-lane vectors. This technique may also be instantiated in software for programmable processors that provide a shuffle instruction across SIMD vectors, one embodiment, decomposed in-place transpositions may have up to 45 times higher throughput than direct vector memory accesses.

In one embodiment, execution may be performed on a SIMD processor divided into arrays of processing elements, where each array may be connected to a shuffle network to allow its processing elements to communicate. In another embodiment, each processing element may hold a vector of m>0 elements, and processing elements may be grouped in arrays of n>0 items. These processing elements may be connected with a shuffle network that allows each processing element to send one item of data, while receiving one item of data from a single processing element in its array.

In another embodiment, the in-place transposition may redistribute data vectors across SIMD lanes in order to ensure that the loads and stores generated by a SIMD multiprocessor are presented to the memory subsystem as contiguous, SIMD-vector width memory operations, rather than a sequential series of strided memory operations. These transpositions may redistribute memory operations so that the SIMD array collaborates to perform multiple vector memory operations, rather than performing vector memory operations independently for each lane. Presenting contiguous, SIMD-vector width memory operations may ensure maximal memory bandwidth efficiency.

Additionally, in one embodiment, row shuffle, dynamic column rotation, and static row permutation operations may be chosen for the algorithm to enable SIMD execution for vector memory operations. If the matrix A is held in SIMD registers, the access patterns may fit common SIMD instructions. In another embodiment, an SIMD instruction set may provide a row shuffle operation that allows processing elements to communicate with other elements in their array. This shuffle instruction may be used directly to implement the row shuffle operation.

Further, in one embodiment, using the dynamic column rotation operation, each processing element may rotate its vector by some distance, determined dynamically. This may be equivalent to the column rotation operation. This operation may be implemented for SIMD processors performing vector memory operations. Since each SIMD lane may rotate by a different amount, if this rotation were implemented with branching based on the rotation amount, this primitive may introduce SIMD divergence. To avoid this problem, the rotation may be performed analogously to a VLSI barrel rotation.

For example, the rotation may be performed in-place in ┌log₂ m┐ steps, by iterating over the bits of the rotation amount, and conditionally rotating each SIMD lane's vectors by distance d=2^{k} at each step. This may eliminate branches, even when each SIMD lane rotates its array by a different amount. Since most architectures do not allow dynamically indexable register files, this approach may use completely static register indexing, using conditional moves to perform the dynamic rotation. On architectures with dynamically indexable register files, this may be done with only 1 instruction per element.

Further still, in one embodiment, using the static row permutation operation, each processing element may statically permute its vector in the same way. The static row permutation operation may be equivalent to the row permutation operation. Since the permutation is statically known, and is constant for all processing elements, in many cases this permutation may be implemented statically without any hardware instructions: it may be performed by logically renaming elements in each column vector.

Also, in one embodiment, the decomposed in-place matrix transposition may be used in association with one or more databases. For example, a database may store information in “row-oriented” or “column-oriented” fashion. The decomposed in-place matrix transposition may be used directly to convert between these data formats. This may avoid expensive conversions, and since databases are typically large, in-place conversion may be more valuable than out-of-place conversion.

Additionally, in one embodiment, the decomposed in-place matrix transposition may be used in association with one or more memory controllers. In one embodiment, the decomposed in-place matrix transposition may be used to create memory controllers which provide SIMD memory accesses with an arbitrary length vector for each lane. This may be done by providing the memory controller with a SIMD state machine, per-lane RAMs, and a shuffle network between SIMD lanes. The advantage of this approach, compared to performing the transpose in a large RAM directly is that the decomposed in-place matrix transposition approach provides two benefits: that memory accesses may be local to a SIMD lane, which means the RAM may be implemented as several small, private RAMs accessed per-lane rather than by a SIMD vector, and secondly, that the accesses may have no bank conflicts, removing the need for replay machinery.

This may also be used to synthesize custom memory controllers which provide efficient memory access for arrays of custom hardware engines, whether implemented in VLSI circuits or reprogrammable logic arrays.

In this way, decomposition for in-place matrix transposition may be performed. This decomposition may reduce the overall transposition into a series of parallel permutations on rows and columns of the original matrix. These row-wise and column-wise permutations may be much smaller than the size of the overall matrix, and so performing them may be simpler and may require less temporary storage space, less computation, etc.

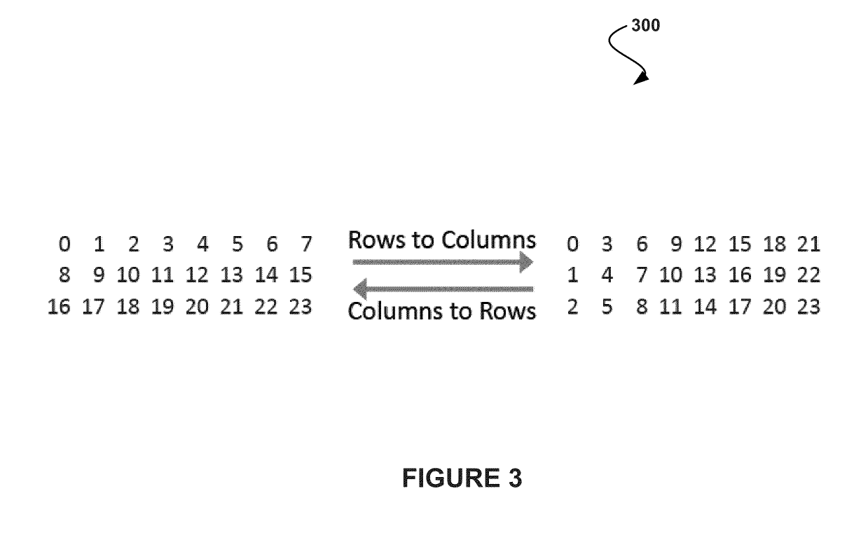

In one embodiment, after the row-wise and column-wise permutations are performed, the storage of the original m×n matrix is reinterpreted as an m×n matrix, completing the transpose. The transposition may be accomplished by means of two permutations—“rows to columns” (R2C) or “columns to rows” (C2R). The R2C permutation is the inverse permutation of the C2R permutation, FIG. 3 illustrates examples 300 of these two transposition permutations where m=3 and n=8.

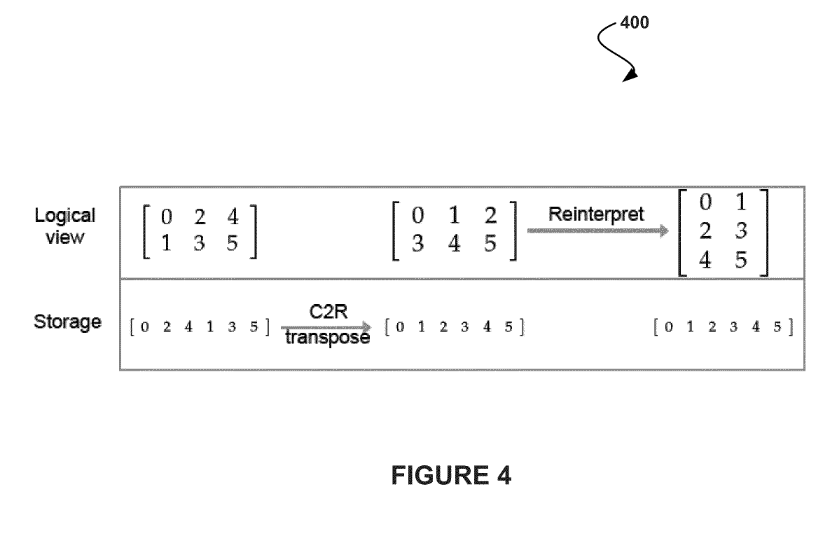

In another embodiment, memory may be structured as a linear array, onto which elements of two dimensional matrices are mapped, following either row-major or column-major order. FIG. 4 shows the transposition 400 of a 2×3 dimensional matrix, laid out in row-major order, using a C2R transposition permutation. For general matrix transposition, the distinction between R2C and C2R may depend on the linearization of the matrix. For example, C2R transpositions may be used for row-major matrices, and R2C transpositions may be used for column-major matrices.

However, if the matrix dimensions are first swapped before conducting the transposition, C2R transpositions can be used for column-major matrices, and vice-versa. This flexibility may be used to improve performance in some cases. For vector memory operations, the two directions remain distinct due to constraints on SIMD instruction sets: The R2C transposition may be used for performing vector loads, and the C2R transposition may be used for performing vector stores. However, the entire permutation required for performing the transposition in-place on a matrix may not need to be considered. Instead, the transposition may be decomposed into independent row-wise and column-wise steps.

In this way, the in-place transposition problem may be decomposed into independent row-wise and column-wise permutations. By decomposing the transposition, the algorithmic complexity may be improved. For example, for a case where auxiliary storage is O(max(m, n)), time complexity may be reduced from O(k log k) O(k), where k=mn, and no cycle-following is done. For a case where auxiliary storage is O(l), cycle-following may be used on reduced permutations time complexity may be improved from O(k log k) to O(k log max(m, n)).

The regular nature of the row-wise and column-wise permutations may make the decomposed transposition efficient on parallel hardware, which may ensure perfect load-balancing because the rows and columns are operated independently. This may be in contrast to traditional cycle-following algorithms, where cycle lengths can be poorly distributed.

Mapping this algorithm to computer hardware efficiently involves considering how these row-wise and column-wise permutations map to on-chip memory systems, for example caches and scratchpad memories. Because of the properties of this algorithm, implementors are free to choose row-major or column-major indexing while performing these permutations, regardless of the native memory linearization of the matrix

Choosing a canonical indexing scheme allows implementations to map row-wise and column-wise permutations onto the memory system in a canonical way. For example, an embodiment may choose to treat all matrices as row-major linearized, in order to ensure that all row operations map to cache-lines of a processor with a cache.

The dynamic column-wise operations can be optimized to use caches effectively through cycle following. Column rotation can be decomposed into two operations: a coarse rotation that uses an analytic solution for cycle following to rotate groups of columns together without using any temporary storage. Because the cycles can easily be computed analytically for rotations, no auxiliary storage is needed. The goal of the coarse rotation is to ensure that residual rotation amounts are bounded. This is only possible due to the nature of the rotation amounts given earlier. Then, the fine rotation pass also performs rotation without using any temporary storage, using on-chip memories such as scratchpads and caches to efficiently load in blocks of data, performing the rotation on-chip, and then storing the result efficiently to memory.

The static row-permutation operations can also be made to use caches more effectively through cycle following. This technique permutes groups of columns together, so as to ensure cache-lines are fully utilized. Because all rows are permuted identically, we need store cycle descriptors only for the upper bound of m/2 cycles in auxiliary memory.

Other implementations can take advantage of properties of the matrix to perform the transposition more efficiently. For example, when converting Arrays of Structures to Structures of Arrays, and vice versa, the problem is equivalent to transposing very skinny matrices with either large numbers of rows and a very small number of columns, or vice versa. If one of the dimensions is very small, we can fit all column operations into on-chip memory by using the appropriate R2C or C2R transposition algorithm. This cuts down on the number of passes required over the data complete the transposition.

Another important optimization involves strength reduction: because the indexing equations require repeated integer division and modulus operations, using a strength reduced version of these operations can bring important performance benefits.

The transpositions we describe can also be used on blocked matrices, using the equations to move blocks of data rather than individual elements. This can be useful for utilizing processor caches.

Additionally, the above permutations may allow for efficient SIMD transpositions on the very small matrices that arise when vector memory operations are implemented on SIMD processors. These memory operations may be useful when performing Array of Structures memory accesses, where each SIMD lane is loading or storing a vector of data. Programmers are often told to reformat their data to Structure of Arrays format in order to achieve good efficiency on SIMD hardware. This may be cumbersome, and at times impractical, such as when each SIMD lane is consuming or producing a vector of data, a technique which can improve overall efficiency by performing more sequential work, requiring less parallelism with its associated overhead. The above decomposition may allow the transposition to be efficiently performed on SIMD hardware, enabling full memory bandwidth can be achieved even when each SIMD lane operates on an arbitrarily long vector.

The above method can also be applied to convert databases between row-oriented and column-oriented forms, as well as to simplify the creation of memory controllers for SIMD processors that provide efficient vector memory accesses.

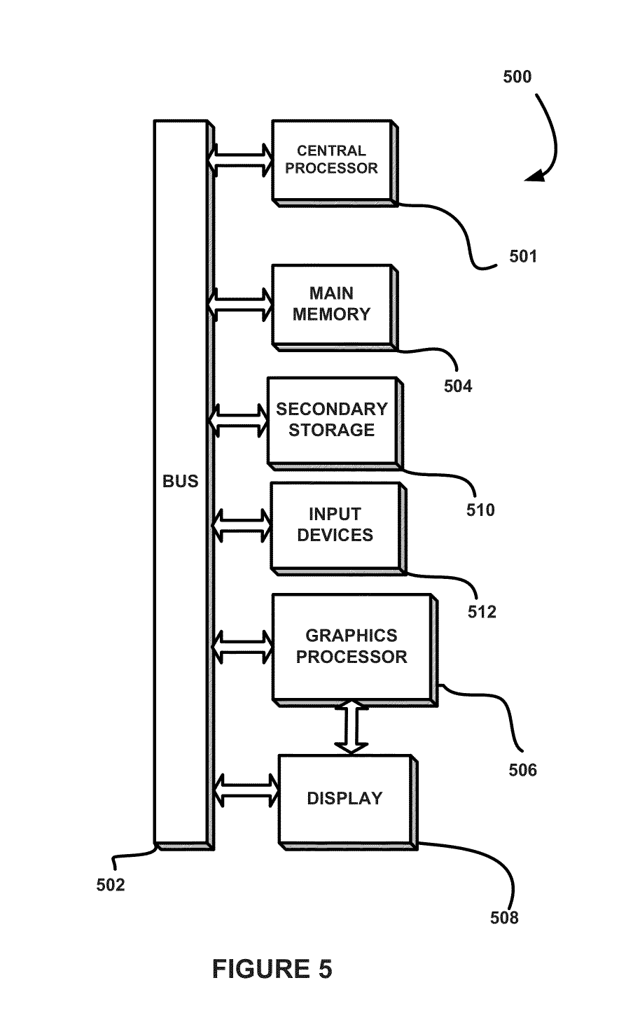

FIG. 5 illustrates an exemplary system 500 in which the various architecture and/or functionality of the various previous embodiments may be implemented. As shown, a system 500 is provided including at least one host processor 501 which is connected to a communication bus 502. The system 500 also includes a main memory 504. Control logic (software) and data are stored in the main memory 504 which may take the form of random access memory (RAM).

The system 500 also includes a graphics processor 506 and a display 508, i.e. a computer monitor. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user. The system may also be realized by reconfigurable logic which may include (but is not restricted to) field programmable gate arrays (FPGAs).

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 504 and/or the secondary storage 510. Such computer programs, when executed, enable the system 500 to perform various functions. Memory 504, storage 510, volatile or non-volatile storage, and/or any other type of storage are possible examples of non-transitory computer-readable media.

In one embodiment, the architecture and/or functionality of the various previous figures may be implemented in the context of the host processor 501, graphics processor 506, an integrated circuit (not shown) that is capable of at least a portion of the capabilities of both the host processor 501 and the graphics processor 506, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, laptop computer, and/or any other type of logic. Still yet, the system 500 may take the form of various other devices including, hut not limited to a personal digital assistant (PDA) device, a mobile phone device, a television, etc.

Further, while not shown, the system 500 may be coupled to a network [e.g. a telecommunications network, local area network (LAN), wireless network, wide area network (WAN) such as the Internet, peer-to-peer network, cable network, etc.] for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying a matrix;
transposing the matrix by performing row-wise operations and column-wise operations, where the row-wise operations and the column-wise operations are performed independently.

2. The method of claim 1, wherein the matrix is transposed utilizing a row-to-column (R2C) transposition.

3. The method of claim 1, wherein the matrix is transposed utilizing a column-to-row (C2R) transposition.

4. The method of claim 1, wherein the row-wise operations include a row shuffle operation that selects a row of the matrix and rearranges elements within the row of the matrix.

5. The method of claim 4, wherein the row shuffle operation creates a reordered row containing a rearrangement of the elements within the row of the matrix, where the rearrangement is made according to an order identified by an input vector.

6. The method of claim 5, wherein the row of the matrix may be overwritten with the reordered row.

7. The method of claim 1, wherein the column-wise operations include a column rotation operation that rotates a column of the matrix by a predetermined distance, such that elements are consecutively removed from a top of the column and added to a bottom of the column.

8. The method of claim 1, wherein the column-wise operations include a row permutation operation that interchanges an entire row of the matrix with another entire row of the matrix.

9. The method of claim 1, wherein the row-wise operations and the column-wise operations are performed independently such that each operation is performed independently of the other operations.

10. The method of claim 1, wherein conflicts are avoided when the row-wise operations and the column-wise operations are performed.

11. The method of claim 1, wherein all row-wise operations and column-wise operations are performed without needing to send one or more elements in the matrix to more than one location within the matrix at the same time.

12. The method of claim 1, wherein transposing the matrix includes preparing the matrix to eliminate conflicts.

13. The method of claim 12, wherein the matrix is prepared by performing one or more column rotation operations and row permutation operations on the matrix.

14. The method of claim 12, wherein transposing the matrix includes performing one or more row shuffle operations on the matrix once the matrix has been prepared.

15. The method of claim 14, wherein transposing the matrix includes performing one or more column rotation operations and one or more row permutation operations to ensure entries in the matrix are in a proper order after the one or more row shuffle operations have been performed.

16. The method of claim 1, wherein conflicts are eliminated during the transposing.

17. The method of claim 1, wherein auxiliary storage is used to store a row or column of the matrix when transposing the matrix.

18. The method of claim 1, wherein identifying and transposing the matrix are performed as part of one or more single instruction, multiple data (SIMD) vector memory accesses.

19. The method of claim 1, wherein identifying and transposing the matrix are performed as part of a memory controller implementation.

20. A non-transitory computer-readable storage medium storing instructions that, when executed by a processor, cause the processor to perform steps comprising:
identifying a matrix;
transposing the matrix by performing row-wise operations and column-wise operations, where the row-wise operations and the column-wise operations are performed independently.

21. A system, comprising:
a processor for identifying a matrix and transposing the matrix by performing row-wise operations and column-wise operations, where the row-wise operations and the column-wise operations are performed independently.
